(19) United States
(12) Patent Application Publication
(10) Pub. No.: US 2026/0279092 A1
(43) Pub. Date: Sep. 17, 2026

(54) HAND DETECTION WITH CLUSTERING OF SLAM FEATURES

(71) Applicants: Kai Zhou, Weiner Neudorf (AT); Corrado Avolio, Vienna (AT)

(72) Inventors: Kai Zhou, Weiner Neudorf (AT); Corrado Avolio, Vienna (AT)

(21) Appl. No.: 19/076,187

(22) Filed: Mar. 11, 2025

(51) Int. Cl. G06V 40/10; G06T 7/579; G06V 10/25; G06V 10/762; G06V 10/82

(52) U.S. Cl. CPC G06V 40/10; G06T 7/579; G06V 10/25; G06V 10/762; G06V 10/82; G06T 2207/20024; G06T 2207/20084; G06T 2207/30196

(57) ABSTRACT

The method involves accessing image data from consecutive frames generated by one or more cameras of a device. A visual Simultaneous Localization and Mapping (SLAM) processing is performed on the image data to detect and track visual features. In the image data, a region of interest is identified by detecting clusters of visual features that either appear and then disappear in consecutive frames or existing tracked features that suddenly lose tracking. Following the identification of the region of interest, a hand detection processing is performed within this area.

### TECHNICAL FIELD

The subject matter disclosed herein generally relates to hand detection systems. More specifically, but not exclusively, the subject matter relates to hand detection using a visual Simultaneous Localization and Mapping (SLAM) system.

### BACKGROUND

Augmented reality (AR) systems have become increasingly common, with AR glasses requiring continuous hand-tracking capabilities to facilitate natural user interactions. However, traditional hand detection methods encounter significant technical challenges, particularly regarding power consumption and computational efficiency.

In current AR systems, hand detection typically consumes a considerable portion of the device's power budget, leading to a substantial drain on limited battery resources. This high power consumption results from conventional hand detection methods needing to continuously scan the entire camera image to locate and track hands, even when no hands are present in the field of view.

This situation creates a technical challenge for AR systems, as they must balance the need for responsive and accurate hand tracking against the power limitations of wearable devices. The issue is particularly pressing because hand detection must operate almost continuously during AR usage to ensure seamless interaction. However, the energy demands of traditional full-image scanning methods are unsustainable for prolonged use.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating a network environment for operating a display device in accordance with one example embodiment.

FIG. 2 is a block diagram illustrating a display device in accordance with one example embodiment.

FIG. 3 is a block diagram depicting the SLAM-based hand detection system in accordance with one example embodiment.

FIG. 4 is a block diagram illustrating a feature clustering module in accordance with one example embodiment.

FIG. 5 is a flow diagram illustrating a method for hand detection in a targeted area in accordance with one example embodiment.

FIG. 6 is a flowchart depicting the monitoring of SLAM features and detecting hands by searching the entire image with a preset framerate in accordance with one example embodiment.

FIG. 7 is a flow diagram illustrating a method for hand detection in a targeted area in accordance with one example embodiment.

FIG. 8 is a flow diagram illustrating a method for hand detection in a targeted area in accordance with one example embodiment.

FIG. 9 illustrates SLAM feature tracking patterns when a hand enters the field of view, showing tracked features and their behavior in accordance with one example embodiment.

FIG. 10 illustrates a potential hand region identified through clustering of SLAM features, showing how the system narrows down the area for hand detection in one example embodiment.

FIG. 11 is block diagram showing a software architecture within which the present disclosure may be implemented, according to an example embodiment.

FIG. 12 is a diagrammatic representation of a machine in the form of a computer system within which a set of instructions may be executed for causing the machine to perform any one or more of the methodologies discussed herein, according to one example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

The present application describes a system for hand detection using Simultaneous Localization and Mapping (SLAM) feature analysis. In particular, the system leverages existing SLAM processing infrastructure to identify potential hand presence through feature-tracking anomalies.

In traditional hand detection systems, finding and tracking hands consumes a significant amount of power. This is mainly because these systems constantly scan the entire camera image to locate hands, even when no hands are present. The current application addresses this issue by being more selective about where it looks for hands. For instance, the system monitors specific patterns in the SLAM (Simultaneous Localization and Mapping) features that indicate a hand might be entering the camera's view. These patterns occur when new features suddenly appear and then disappear, or when existing features become blocked—both of which typically happen when a hand moves into view. By concentrating on these areas of interest, the system can detect hands reliably while using significantly less power.

To further improve hand detection accuracy, the system takes into account the expected hand size and the typical distance of the hand from the camera (considering standard arm lengths). It also monitors the edges of the image more frequently because that's where hands usually enter the view, while reducing checks in the center.

In one implementation, the system uses dual-mode feature pattern recognition algorithms to observe specific behaviors of SLAM features: (1) the emergence and subsequent loss of new features across consecutive frames, and (2) the sudden occlusion of previously tracked features. These observed patterns are analyzed using clustering algorithms, with clusters being filtered through predetermined constraints based on standard hand dimensions and expected arm length parameters (e.g., 30-75 centimeters).

The system architecture supports both single-stage and dual-stage detection methodologies. In single-stage implementations, it adjusts feature grid likelihood values and generates optimized anchor bounding boxes to guide neural network processing. In dual-stage implementations, the system skips the initial bounding box detection phase and routes regions of interest directly to secondary object detection stages, thus reducing computational overhead.

Additionally, power efficiency is enhanced through a spatially-aware processing hierarchy. Here, feature clustering operations are executed at varying frequencies depending on their spatial location within the image frame. Border regions, where hand entry events usually begin, are processed at higher frequencies, while central areas undergo analysis at reduced frequencies. This adaptive processing strategy ensures reliable detection while optimizing power usage, leading to lower energy consumption compared to traditional methods.

The system's integration with existing SLAM infrastructure eliminates redundant computational processes by leveraging inherent feature detection and tracking mechanisms typical in tracking systems, such as those used in Augmented Reality applications. This architectural efficiency, combined with intelligent region-of-interest targeting, results in an optimized hand detection system that significantly reduces the computational load on power-constrained mobile devices.

In one example embodiment, the present application describes a method for hand detection using SLAM. In one aspect, the method involves accessing image data from consecutive frames generated by one or more cameras of a device. A visual Simultaneous Localization and Mapping (SLAM) processing is performed on the image data to detect and track visual features. In the image data, a region of interest is identified by detecting clusters of visual features that either appear and then disappear in consecutive frames or existing tracked features that suddenly lose tracking. Following the identification of the region of interest, hand detection processing is performed within this area.

As a result, one or more of the methodologies described herein facilitate solving the technical problem of limited computation resources on a mobile device. The presently described method provides an improvement to the operation of the functioning of a computer by reducing power consumption related to hand-tracking using a camera of a mobile device. As such, one or more of the methodologies described herein may obviate a need for certain efforts or computing resources. Examples of such computing resources include processor cycles, network traffic, memory usage, data storage capacity, power consumption, network bandwidth, and cooling capacity.

For purposes of the present application, the following definitions establish technical terms used throughout the specification and claims:

“SLAM Features” refer to the visual elements detected and tracked by a Simultaneous Localization and Mapping system (SLAM) through the AR device's outward-facing cameras. These comprise low-level image features, particularly corners, that are detected in each frame and used for environmental mapping. The SLAM system operates under the assumption that these features originate from static objects in the environment, with their expected motion calculated based on IMU sensor data.

“Tracking Anomalies” encompasses specific patterns in SLAM feature behavior that indicate potential hand presence in the field of view. These anomalies manifest in two primary forms: first, when new features appear and subsequently lose tracking across consecutive frames, and second, when previously tracked features suddenly become blocked or lose tracking. These patterns deviate from the IMU-predicted movement, causing the SLAM system to reject these features as non-static elements.

“Confidence Threshold” defines a predetermined value that indicates sufficient certainty in hand detection results to warrant bypassing full-image scanning. When hand detection within regions of interest achieves a confidence level exceeding this threshold, the system optimizes processing by skipping analysis of the remaining image areas.

“Feature Clustering” describes the systematic process of grouping SLAM features that exhibit similar tracking anomalies. This process incorporates spatial grouping based on expected hand dimensions and assumed arm-to-camera distance relationships. The clustering algorithm applies size-based filtering constraints to eliminate outliers and noise, ensuring reliable hand detection.

“Hand Detection Processing” encompasses two distinct methodological approaches. In one-stage methods, the system employs adjusted feature grid likelihoods and anchor bounding boxes to guide neural network processing. Two-stage methods optimize efficiency by bypassing initial bounding box detection and directly processing regions of interest. The system implements variable frequency processing, with higher rates at image borders where hands typically enter the field of view.

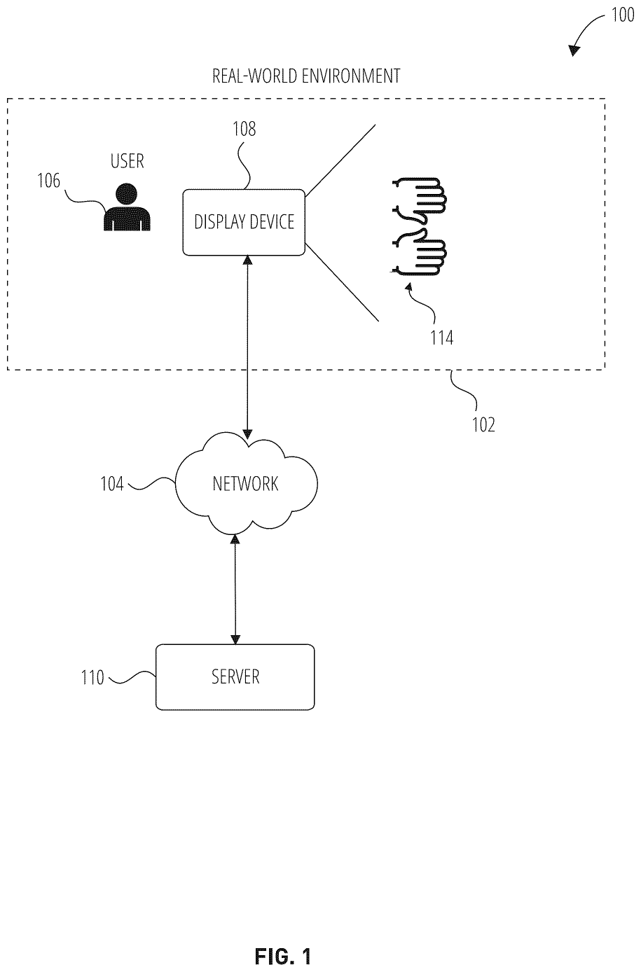

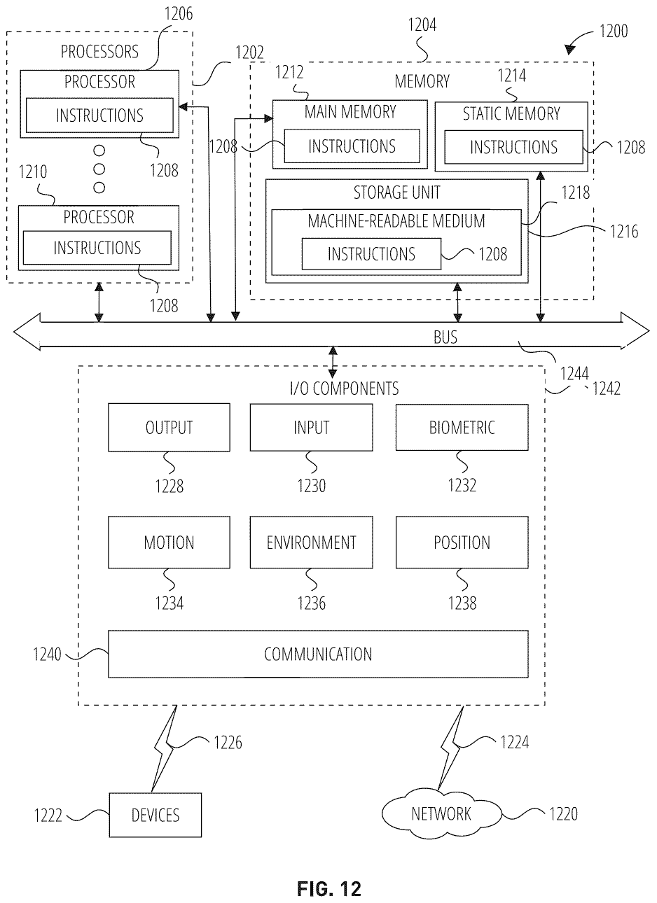

FIG. 1 is a network diagram illustrating a network environment 100 suitable for operating a display device 108, according to some example embodiments. The network environment 100 includes a display device 108 and a server 110, communicatively coupled to each other via a network 104. The display device 108 and the server 110 may each be implemented in a computer system, in whole or in part, as described below with respect to FIG. 12. The server 110 may be part of a network-based system. For example, the network-based system may be or include a cloud-based server system that provides additional information, such as virtual content (e.g., three-dimensional models of virtual objects) to the display device 108.

A user 106 operates the display device 108. The user 106 may be a human user (e.g., a human being), a machine user (e.g., a computer configured by a software program to interact with the display device 108), or any suitable combination thereof (e.g., a human assisted by a machine or a machine supervised by a human). The user 106 is not part of the network environment 100, but is associated with the display device 108.

The display device 108 can include a computing device with a display such as a smartphone, a tablet computer, or a wearable computing device (e.g., watch or glasses). The computing device may be hand-held or may be removably mounted to a head of the user 106. In one example, the display may be a screen that displays what is captured with a camera of the display device 108. In another example, the display of the display device 108 may be transparent (e.g., translucent) such as in lenses of wearable computing glasses. In another example embodiment, the display may be non-transparent and wearable by the user 106 to cover the field of vision of the user 106.

The display device 108 includes a tracking system (not shown). The tracking system tracks the pose (e.g., position and orientation) of the display device 108 relative to the real-world environment 102 using optical sensors (e.g., depth-enabled 3D camera, image camera), inertial sensors (e.g., gyroscope, accelerometer), wireless sensors (Bluetooth, Wi-Fi), GPS sensor, and audio sensor to determine the location of the display device 108 within the real-world environment 102. In another example embodiment, the tracking system tracks the pose of the hand 114 in video frames captured by the optical sensors. For example, the tracking system may use existing data from a SLAM system at the display device 108 to detect and identify the hand 114.

In one example, the display device 108 utilizes outward-facing cameras to capture visual data, which is used for both SLAM (Simultaneous Localization and Mapping) processing and hand detection operations. The display device processes the image data to detect and track SLAM features while simultaneously monitoring for the presence of hands through feature pattern analysis.

The outward-facing cameras capture images of the surrounding environment, generating data that the SLAM system processes to identify low-level features, such as corners. These features are tracked across consecutive frames, with their expected movement calculated using data from inertial measurement units (IMUs). When hands enter the camera's field of view, the system recognizes specific patterns in the behavior of SLAM features. This includes both newly appearing features that subsequently lose tracking and existing features that become obstructed.

The network environment 100 may contain various static objects that produce stable SLAM features, which the system uses as reference points to differentiate hand-related feature patterns. The system continuously monitors these features, applying clustering algorithms to identify areas where anomalies in feature tracking suggest potential hand presence. This method enables power-efficient hand detection by concentrating processing resources on specific regions of interest, rather than continuously scanning the entire field of view.

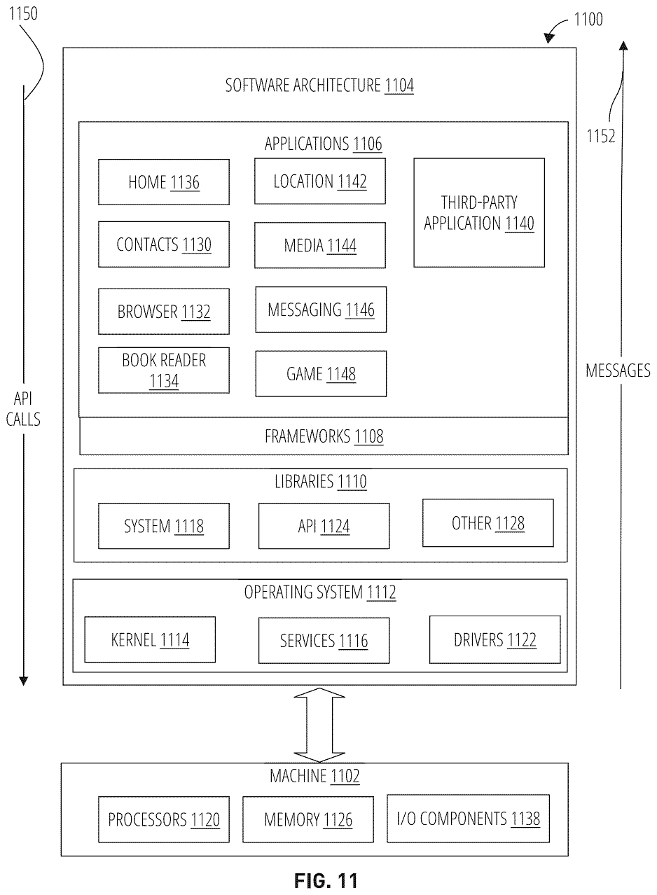

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 11 to FIG. 12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 104 may be any network that enables communication between or among machines (e.g., server 110), databases, and devices (e.g., display device 108). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof.

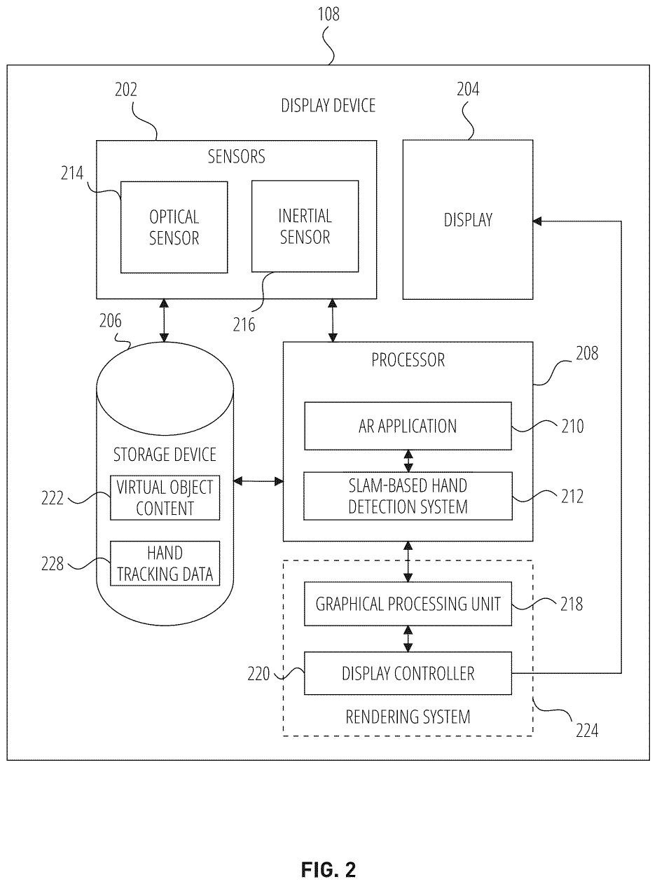

FIG. 2 is a block diagram illustrating modules (e.g., components) of the display device 108, according to some example embodiments. The display device 108 includes sensors 202, an IR emitter 232, a display 204, a processor 208, a rendering system 224, and a storage device 206. Examples of display device 108 include a head-mounted device, a wearable computing device, a desktop computer, a vehicle computer, a tablet computer, a navigational device, a portable media device, or a smartphone.

In one example, the sensors 202 include, for example, the optical sensor 214 (e.g., stereo cameras, camera such as a color camera, a depth sensor, and one or multiple grayscale, global shutter tracking cameras) and an inertial sensor 216 (e.g., gyroscope, accelerometer). Other examples of sensors 202 include a proximity or location sensor (e.g., near field communication, GPS, Bluetooth, Wifi), an audio sensor (e.g., a microphone), or any suitable combination thereof. It is noted that the sensors 202 described herein are for illustration purposes and the sensors 202 are thus not limited to the ones described above.

The optical sensor 214 captures image data for SLAM feature detection, and the inertial sensor 216 provides motion data used to predict feature movement patterns. These sensors work in conjunction to enable the detection and tracking of visual features while monitoring for tracking anomalies that indicate potential hand presence.

The display 204 includes a screen or monitor configured to display images generated by the processor 208. In one example embodiment, the display 204 may be transparent/ translucent or semi-transparent so that the user 106 can see through the display 204 (in AR use case). In another example, the display 204, such as a LCOS display, presents each frame of virtual content in multiple presentations.

The display presents augmented reality content to the user while the system continuously monitors for hand presence using SLAM (Simultaneous Localization and Mapping) feature analysis. The entire architecture is designed to support both one-stage and two-stage hand detection methods, allowing for adjustments in processing frequencies based on different spatial regions within the image frame. The system can switch between high-frequency feature clustering around the edges of the image and lower-frequency processing in the central areas. This approach optimizes power consumption while maintaining reliable detection.

The processor 208 runs an augmented reality (AR) application 210 and a simultaneous localization and mapping (SLAM)-based hand detection system 212. In one example, the AR application 210 encompasses mixed reality (MR) or extended reality (XR) applications. Mixed reality (MR) and extended reality (XR) refer to a range of immersive technologies that blend the physical and digital worlds, creating environments where real and virtual elements coexist and interact in real-time. These technologies include augmented reality (AR), virtual reality (VR), and hybrid systems that combine aspects of both.

In mixed-reality environments, users can interact with digital objects that are seamlessly integrated into their physical surroundings or experience fully immersive virtual worlds that respond to their movements and actions. This technology facilitates more natural and intuitive interactions with digital content, making it especially valuable in fields such as education, healthcare, engineering, and entertainment. Mixed reality systems often employ advanced hand-tracking technologies, such as the shadow-based method described in this invention, allowing users to manipulate virtual objects with their hands. This enhances the sense of immersion and enables more precise control within digital environments.

In one example, the processor 208 executes an AR application 210 that integrates with the SLAM-based hand detection system 212. This SLAM-based hand detection system 212 processes the sensor data to identify SLAM features and analyze their behavior patterns, particularly focusing on features that exhibit sudden tracking loss or blocking when hands enter the field of view.

The storage device 206 maintains virtual object content 222 and stores hand tracking data 228, which includes historical information about hand dimensions and tracking patterns that can be used to optimize detection parameters.

The rendering system 224 includes a Graphical Processing Unit 218 and a display controller 220. The Graphical Processing Unit 218 includes a render engine (not shown) that is configured to render a frame of a 3D model of a virtual object based on the virtual content provided by the AR application 210 and the pose of the display device 108. In other words, the Graphical Processing Unit 218 uses the three-dimensional pose of the display device 108 to generate frames of virtual content to be presented on the display 204. For example, the Graphical Processing Unit 218 uses the three-dimensional pose to render a frame of the virtual content such that the virtual content is presented at an appropriate orientation and position in the display 204 to properly augment the user's reality. As an example, Graphical Processing Unit 218 may use the three-dimensional pose data to render a frame of virtual content such that, when presented on display 204, the virtual content appears anchored to surface 112 in the user's real-world environment 102. The Graphical Processing Unit 218 generates updated frames of virtual content based on updated three-dimensional poses of the display device 108, which reflect changes in the position and orientation of the user 106 in relation to the surface 112 in the user's real-world environment 102.

The Graphical Processing Unit 218 transfers the rendered frame to the display controller 220. The display controller 220 is positioned as an intermediary between the Graphical Processing Unit 218 and the display 204, receives the image data (e.g., annotated rendered frame) from the Graphical Processing Unit 218, and provides the annotated rendered frame to the display 204.

The storage device 206 stores virtual object content 222 and hand tracking data 228. The virtual object content 222 includes, for example, a database of visual references (e.g., images, QR codes) and corresponding virtual content (e.g., a three-dimensional model of virtual objects). The hand tracking data 228 is generated by the SLAM processing module 226.

Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

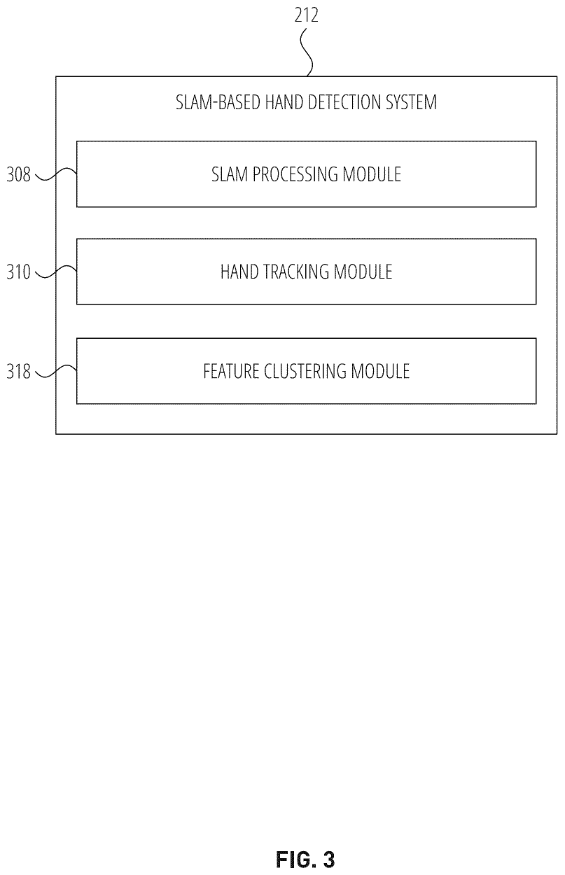

FIG. 3 illustrates the SLAM-based hand detection system 212 in accordance with one example embodiment. The SLAM-based hand detection system 212 includes, for example, a SLAM processing module 308, a hand tracking module 310, and a feature clustering module 318.

The SLAM (Simultaneous Localization and Mapping) processing module 308 analyzes image data from outward-facing cameras to detect and track low-level visual features across consecutive frames. This module calculates the expected movement of features based on data from the Inertial Measurement Unit (IMU) and identifies any features that show tracking anomalies when hands enter the field of view.

The hand tracking module 310 works in conjunction with the SLAM processing module 308 to examine regions where tracking anomalies indicate potential hand presence. This module utilizes both one-stage and two-stage detection methods, adjusting the likelihood of features in a grid and processing specific regions of interest based on clusters of SLAM features that exhibit sudden tracking loss or blocking patterns.

In one-stage detection methods, the system manipulates the likelihood values of feature grids that may contain hand regions, providing these areas as anchor bounding boxes to assist the neural network's search process. This approach enables direct modification of detection priorities within a single processing stage, allowing the system to prioritize computational resources on regions where SLAM features suggest the presence of hands.

In two-stage detection methods, the system can skip the initial bounding box detection stage if the SLAM features indicate high probability regions for hands. Instead of performing the first-stage full-image bounding box detection, it feeds the identified regions of interest directly into the second-stage object detection process. If hands are detected with sufficient confidence in these regions, the system can bypass the processing of the remainder of the image, resulting in significant computational savings.

Both detection methods integrate with the feature clustering process of the feature clustering module 318, where clusters are filtered based on expected hand dimensions and arm length constraints. For instance, when SLAM features show tracking anomalies in a region that matches typical hand dimensions (based on an arms length range of 30-75 centimeters), the system can either adjust the likelihood values in the one-stage method or process that region directly in the two-stage method. This targeted approach allows the system to maintain detection reliability while reducing power consumption by approximately 30% compared to traditional full-image scanning methods.

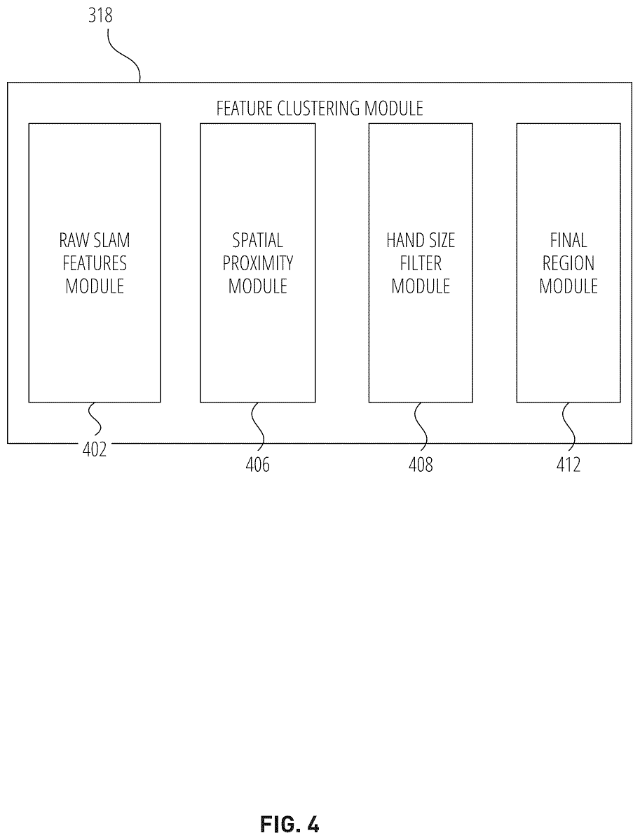

The feature clustering module 318 performs spatial analysis of SLAM features to identify potential hand regions. This module groups features that exhibit similar tracking anomalies while applying size filtering based on expected hand dimensions and arm length constraints. The clustering process considers both scenarios where new features appear and subsequently lose tracking, and where existing tracked features become blocked by hand movement. The feature clustering module 318 will be described in further detail with respect to FIG. 4.

The SLAM processing module 308, hand tracking module 310, and feature clustering module 318 operate continuously during the AR (Augmented Reality) application 210. The SLAM processing module 308 provides foundational tracking data, enabling the feature clustering module 318 to identify regions of interest. These regions are then processed by the hand tracking module 310 using variable frequency analysis, applying higher processing rates to image border areas where hands typically enter the field of view.

FIG. 4 is a block diagram illustrating the feature clustering module 318 according to one embodiment. The feature clustering module 318 analyzes SLAM features through four interconnected components that process and filter feature data to identify potential hand regions.

The raw SLAM features module 402 serves as the initial processing stage, receiving feature tracking data from the SLAM processing module 308. It identifies features that display tracking anomalies characteristic of hand presence.

The spatial proximity module 406 examines the distribution and relationships between features exhibiting these tracking anomalies. This module groups the features based on their spatial relationships, identifying clusters that may indicate hand presence. It processes these features differently depending on their location within the image frame, applying higher frequency analysis for border regions where hands typically enter the field of view, and lower frequency processing for central image areas.

The hand size filter module 408 applies dimensional constraints to the identified feature clusters. These constraints are based on predetermined parameters, including expected hand dimensions and typical arm length ranges from the camera. This filtering step helps eliminate clusters that are either too small to represent a hand or too large to correspond to typical hand movements, thereby reducing false positives in the detection process.

The final region module 412 processes the filtered clusters to output defined regions of interest for targeted hand detection. These regions represent areas where SLAM feature patterns strongly suggest hand presence, warranting focused processing. The module provides these regions to the hand detection system, enabling targeted processing that can bypass full-image scanning when hands are detected with a confidence level above a predetermined threshold.

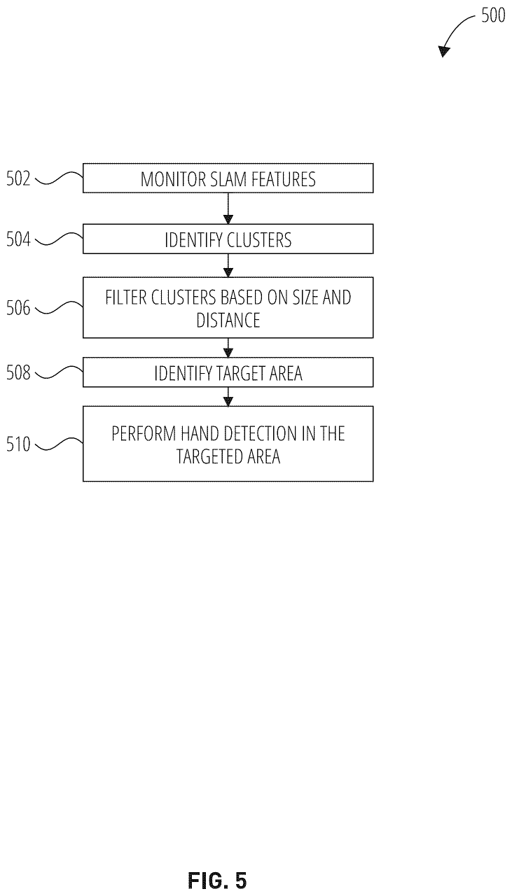

FIG. 5 is a flow diagram that outlines a method for detecting hands in a designated area, in line with one example embodiment. The operations in routine 500 can be carried out by the SLAM-based hand detection system 212, utilizing various components (e.g., modules, engines) described in FIG. 2, FIG. 3, and FIG. 4. Although the routine 500 is exemplified through the SLAM-based hand detection system 212 and hand tracking module 310, it is important to note that some operations of routine 500 may also be implemented on different hardware configurations or by similar components located elsewhere.

At block 502, the system continuously monitors SLAM features. For instance, the SLAM-based hand detection system 212 analyzes feature behavior patterns through its outward-facing cameras. This monitoring stage identifies features that exhibit tracking anomalies typical of hand presence, including both newly appearing features that subsequently lose tracking and existing features that become obstructed.

At block 504, the SLAM-based hand detection system 212 groups SLAM features that demonstrate similar tracking anomalies, identifying clusters. These clusters are then filtered based on size and distance constraints at block 506, utilizing predetermined parameters derived from expected hand dimensions and typical arm lengths ranging from 30 to 75 centimeters. This filtering process helps eliminate clusters that do not match typical hand characteristics, thereby reducing false positives during detection.

At block 508, the SLAM-based hand detection system 212 determines target areas—regions with a high probability of hand presence. These areas are identified based on the spatial distribution of filtered feature clusters and their relation to common hand entry patterns within the field of view. The system applies variable frequency processing to different image regions, allocating higher frequency analysis to border areas where hands are likely to enter the field of view.

At block 510, hand detection is specifically performed within these targeted areas by the SLAM-based hand detection system 212. This focused detection strategy allows the system to optimize power consumption by limiting full-image scanning operations. When hands are detected with a confidence level above a predetermined threshold within these areas, the system can avoid processing other image regions. This targeted approach supports both one-stage detection methods, where feature grid likelihoods are adjusted, and two-stage methods, which can bypass initial bounding box detection in favor of direct region processing.

The process flow depicted in FIG. 5 illustrates the main sequence of operations that enables the system to achieve approximately 30% power savings compared to traditional hand detection methods. This efficiency is realized through the strategic use of the existing SLAM processing infrastructure and intelligent resource targeting based on feature clustering analysis.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

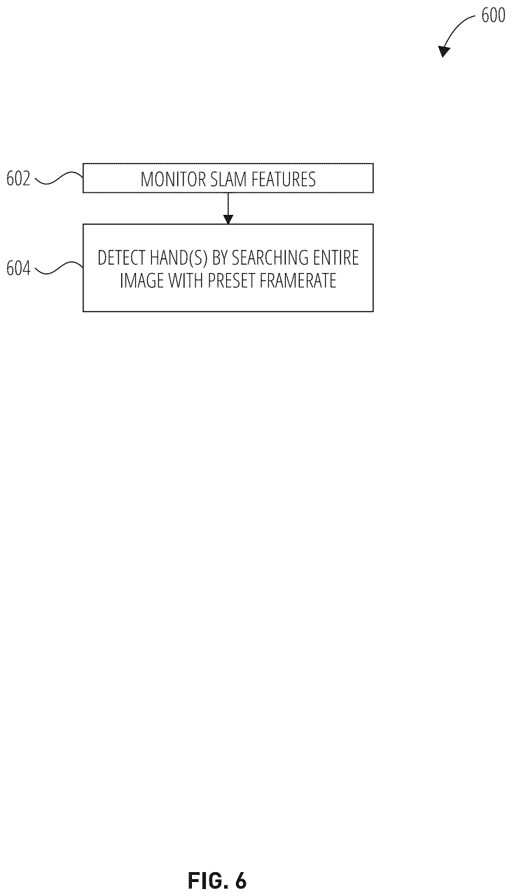

FIG. 6 is a flowchart illustrating the process of monitoring SLAM features and detecting hands by scanning the entire image at a preset frame rate, according to one example embodiment. The operations in routine 600 may be executed by the SLAM-based hand detection system 212, utilizing components (such as modules and engines) described in FIG. 2, FIG. 3, and FIG. 4. Although the routine 600 is explained in relation to the SLAM-based hand detection system 212 and the hand tracking module 310, it should be noted that some operations within routine 600 can be implemented on various hardware configurations or performed by similar components located elsewhere.

In FIG. 6, routine 600 shows the fundamental hand detection process that operates in the absence of identified potential hand regions through SLAM feature analysis. This process consists of two parallel operations that maintain continuous hand detection capability while optimizing power consumption by selectively managing processing tasks.

The first operation, indicated in block 602, involves the monitoring of SLAM features. Here, the SLAM-based hand detection system 212 continuously analyzes feature behavior using outward-facing cameras to detect tracking anomalies that may suggest the presence of hands. This monitoring process is crucial for maintaining awareness of both newly appearing features that may lose tracking and existing features that could become obstructed when hands enter the camera's field of view.

The second operation, highlighted in block 604, focuses on detecting hands by scanning the entire image at a preset (lower) frame rate. This full-image scanning operates at a reduced frequency compared to the targeted detection employed when potential hand regions are identified through SLAM feature analysis. The preset frame rate strikes a balance between ensuring reliable hand detection and minimizing power consumption during periods when no hand presence is indicated by feature tracking anomalies.

This baseline process guarantees continuous hand detection capability while also maintaining power efficiency through reduced scanning frequency. It accommodates both one-stage and two-stage detection methods, enabling the SLAM-based hand detection system 212 to adapt its detection strategy based on the identification of SLAM feature patterns that indicate potential hand regions. When SLAM features suggest hand presence, the SLAM-based hand detection system 212 can shift from this baseline process to more targeted detection approaches that concentrate processing on specific areas of interest.

The simultaneous operation of SLAM feature monitoring and reduced-frequency full-image scanning allows the SLAM-based hand detection system 212 to achieve reliable hand detection while realizing significant power savings compared to traditional methods that necessitate constant full-image scanning at high frame rates.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

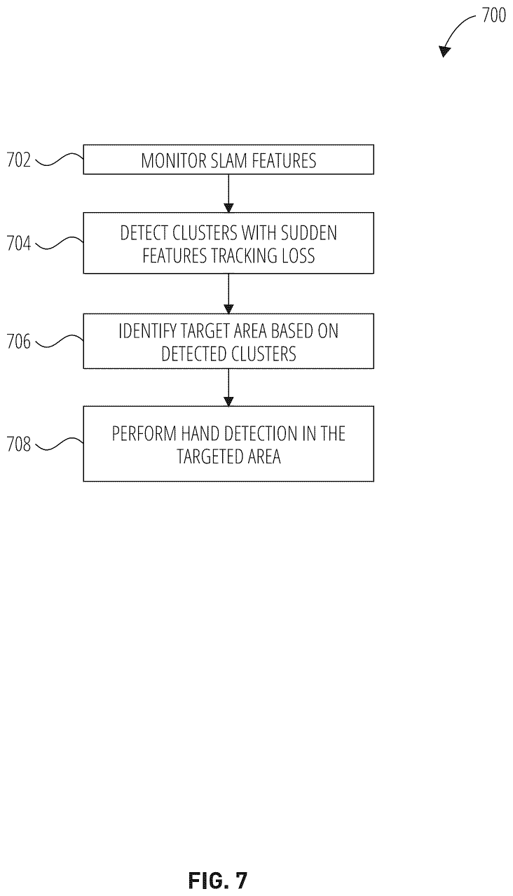

FIG. 7 is a flow diagram illustrating a method for hand detection in a targeted area in accordance with one example embodiment. Operations in the routine 700 may be performed by the SLAM-based hand detection system 212, using components (e.g., modules, engines) described above with respect to FIG. 2, FIG. 3, and FIG. 4. Accordingly, the routine 700 is described by way of example with reference to the SLAM-based hand detection system 212 and hand tracking module 310. However, it shall be appreciated that at least some of the operations of the routine 700 may be deployed on various other hardware configurations or be performed by similar components residing elsewhere.

Referring to FIG. 7, the routine 700 illustrates a specific implementation of the SLAM-based hand detection process that focuses on detecting sudden feature tracking loss. The process begins at block 702, where the SLAM-based hand detection system 212 continuously analyzes feature behavior through the outward-facing cameras to identify patterns indicating potential hand presence.

At block 704, the SLAM-based hand detection system 212 specifically detects clusters with sudden features tracking loss, which occurs when existing tracked features become blocked or occluded. This tracking loss pattern typically manifests when a hand enters the field of view and blocks previously tracked features, particularly at image borders where hands commonly enter. The block 704 analyzes these tracking anomalies to identify potential hand presence without requiring continuous full-image scanning.

At block 706, based on the detected clusters exhibiting tracking loss, the SLAM-based hand detection system 212 identifies target areas that warrant focused hand detection processing. These target areas are determined through spatial analysis of the feature clusters, applying predetermined constraints based on expected hand dimensions and typical arm length ranges of 30-75 centimeters. The identification process considers both the size and location of feature clusters to optimize detection efficiency.

The final stage, at block 708, involves performing hand detection specifically within the targeted areas. This focused detection approach enables the system to process regions where tracking loss suggests hand presence, implementing either one-stage detection methods with adjusted feature grid likelihoods or two-stage methods that bypass initial bounding box detection. When hands are detected with confidence above the predetermined threshold in these targeted areas, the SLAM-based hand detection system 212 can avoid processing the remaining image regions, resulting in significant power savings.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

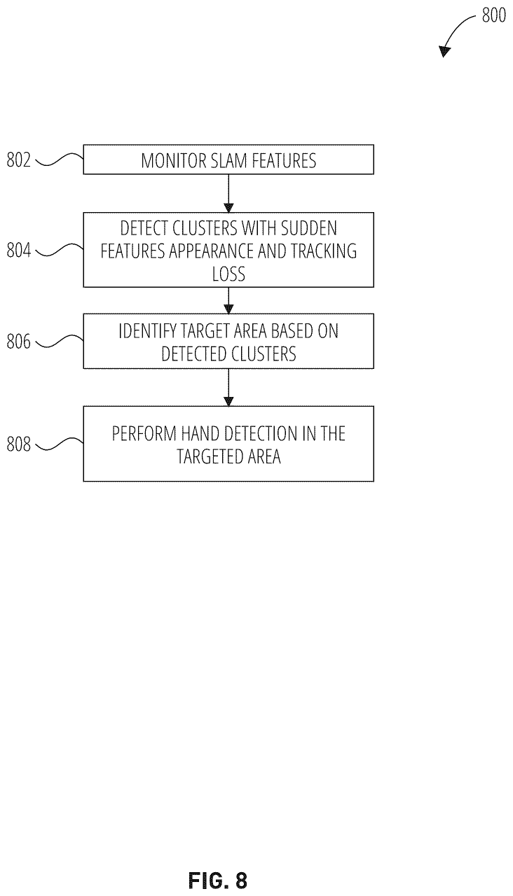

FIG. 8 is a flow diagram illustrating a method for hand detection in a targeted area in accordance with one example embodiment. Operations in the routine 800 may be performed by the SLAM-based hand detection system 212, using components (e.g., modules, engines) described above with respect to FIG. 2, FIG. 3, and FIG. 4. Accordingly, the routine 800 is described by way of example with reference to the SLAM-based hand detection system 212 and hand tracking module 310. However, it shall be appreciated that at least some of the operations of the routine 800 may be deployed on various other hardware configurations or be performed by similar components residing elsewhere.

Referring to FIG. 8, routine 800 illustrates a process for detecting hands through analysis of both feature appearance and tracking loss patterns in SLAM data. The process begins at block 802 with monitoring SLAM features, where the SLAM-based hand detection system 212 continuously analyzes feature behavior through the outward-facing cameras to identify specific patterns that indicate potential hand presence.

At block 804, the SLAM-based hand detection system 212 specifically detects clusters with sudden features appearance and tracking loss, representing a distinct pattern where new features appear and subsequently lose tracking in consecutive frames. This pattern typically occurs when a hand enters a previously empty region of the field of view, creating new SLAM features that cannot be consistently tracked due to hand movement. The detection of these dual-pattern anomalies provides strong indicators of hand presence without requiring continuous full-image scanning.

At block 806, based on the detected clusters exhibiting both appearance and tracking loss, the system identifies target areas for focused hand detection processing. These target areas are determined through spatial analysis of the feature clusters, applying predetermined constraints based on expected hand dimensions and typical arm length ranges of 30-75 centimeters. The identification process considers both the temporal sequence of feature appearance and loss, as well as the spatial distribution of affected features.

At block 808, the final stage involves performing hand detection specifically within the targeted areas. This focused detection approach enables the system to process regions where the dual pattern of feature appearance and tracking loss suggests hand presence, implementing either one-stage detection methods with adjusted feature grid likelihoods or two-stage methods that bypass initial bounding box detection. When hands are detected with confidence above the predetermined threshold in these targeted areas, the system can avoid processing the remaining image regions.

It is to be noted that other embodiments may use different sequencing, additional or fewer operations, and different nomenclature or terminology to accomplish similar functions. In some embodiments, various operations may be performed in parallel with other operations, either in a synchronous or asynchronous manner. The operations described herein were chosen to illustrate some principles of operations in a simplified form.

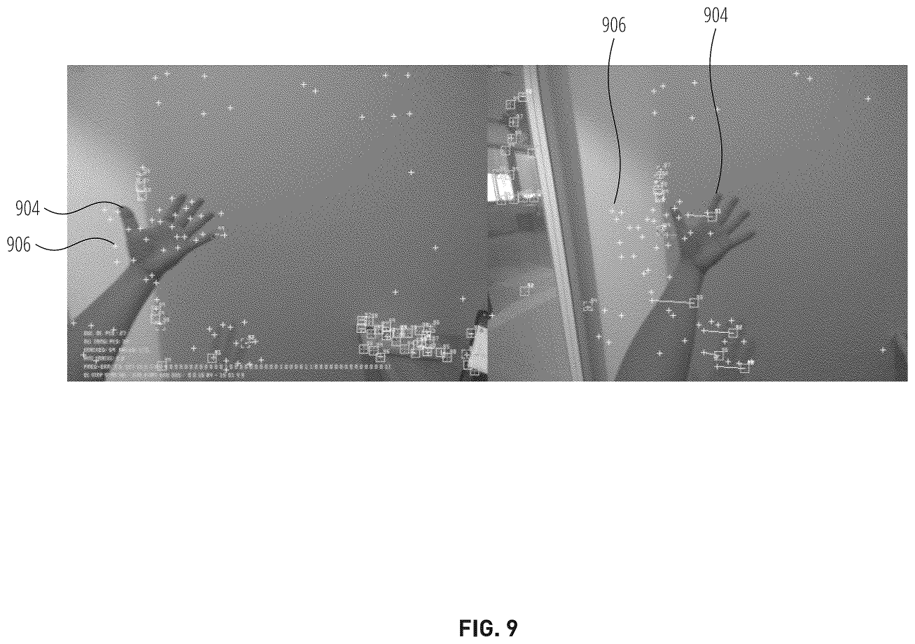

FIG. 9 illustrates SLAM feature tracking patterns when a hand 904 enters the field of view. The figure shows multiple tracked features (904) distributed across the image, with feature confidence values displayed adjacent to each feature. The tracked features (904) are shown with connecting lines (906) indicating their movement patterns across consecutive frames. This visualization demonstrates how SLAM features exhibit sudden tracking loss when a hand enters the field of view, providing key indicators for potential hand presence.

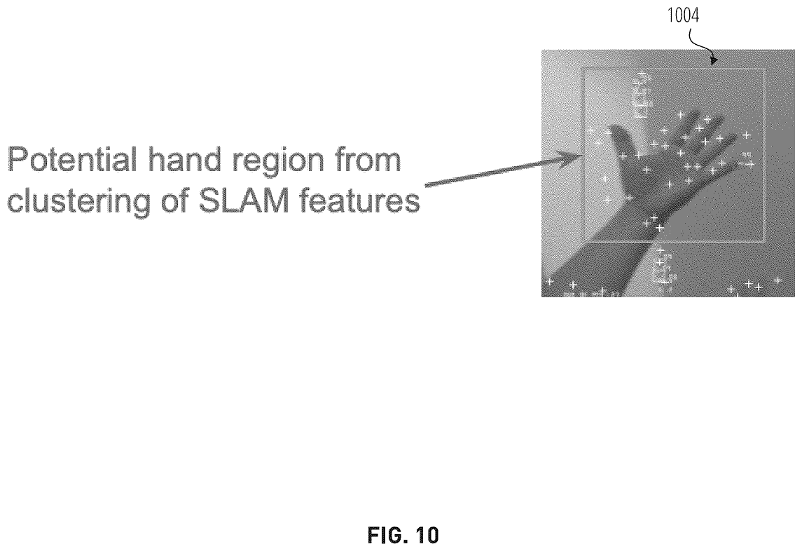

FIG. 10 illustrates a potential hand region (1004) identified through the clustering of SLAM features. This hand region is determined by the spatial proximity of features that exhibit tracking anomalies, such as sudden appearances followed by tracking loss or existing features becoming obstructed. The bounded area represents a zone filtered according to expected hand dimensions and arm length constraints, estimated to be approximately 30 to 75 centimeters from the camera. This region acts as a priority target for subsequent hand detection processing, allowing the system to optimize power consumption by concentrating detection efforts on high-probability areas before performing a full-image scan.

The clustering demonstrated in FIG. 10 specifically shows how the system groups SLAM features that share similar tracking anomalies to identify regions where hands are likely to be present. The bounded region (hand region 1004) illustrates the outcome after applying size filtering and spatial proximity analysis to eliminate outliers and noise while preserving clusters that align with expected hand dimensions.

FIG. 11 is a block diagram 1100 illustrating a software architecture 1104, which can be installed on any one or more of the devices described herein. The software architecture 1104 is supported by hardware such as a machine 1102 that includes Processors 1120, memory 1126, and I/O Components 1138. In this example, the software architecture 1104 can be conceptualized as a stack of layers, where each layer provides a particular functionality. The software architecture 1104 includes layers such as an operating system 1112, libraries 1110, frameworks 1108, and applications 1106. Operationally, the applications 1106 invoke API calls 1150 through the software stack and receive messages 1152 in response to the API calls 1150.

The operating system 1112 manages hardware resources and provides common services. The operating system 1112 includes, for example, a kernel 1114, services 1116, and drivers 1122. The kernel 1114 acts as an abstraction layer between the hardware and the other software layers. For example, the kernel 1114 provides memory management, Processor management (e.g., scheduling), Component management, networking, and security settings, among other functionality. The services 1116 can provide other common services for the other software layers. The drivers 1122 are responsible for controlling or interfacing with the underlying hardware. For instance, the drivers 1122 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1110 provide a low-level common infrastructure used by the applications 1106. The libraries 1110 can include system libraries 1118 (e.g., C standard library) that provide functions such as memory allocation functions, string manipulation functions, mathematic functions, and the like. In addition, the libraries 1110 can include API libraries 1124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1110 can also include a wide variety of other libraries 1128 to provide many other APIs to the applications 1106.

The frameworks 1108 provide a high-level common infrastructure that is used by the applications 1106. For example, the frameworks 1108 provide various graphical user interface (GUI) functions, high-level resource management, and high-level location services. The frameworks 1108 can provide a broad spectrum of other APIs that can be used by the applications 1106, some of which may be specific to a particular operating system or platform.

In an example embodiment, the applications 1106 may include a home application 1136, a contacts application 1130, a browser application 1132, a book reader application 1134, a location application 1142, a media application 1144, a messaging application 1146, a game application 1148, and a broad assortment of other applications such as a third-party application 1140. The applications 1106 are programs that execute functions defined in the programs. Various programming languages can be employed to create one or more of the applications 1106, structured in a variety of manners, such as object-oriented programming languages (e.g., Objective-C, Java, or C++) or procedural programming languages (e.g., C or assembly language). In a specific example, the third-party application 1140 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or Linux OS, or other mobile operating systems. In this example, the third-party application 1140 can invoke the API calls 1150 provided by the operating system 1112 to facilitate functionality described herein.

FIG. 12 is a diagrammatic representation of the machine 1200 within which instructions 1208 (e.g., software, a program, an application, an applet, an app, or other executable code) for causing the machine 1200 to perform any one or more of the methodologies discussed herein may be executed. For example, the instructions 1208 may cause the machine 1200 to execute any one or more of the methods described herein. The instructions 1208 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1208, sequentially or otherwise, that specify actions to be taken by the machine 1200. Further, while only a single machine 1200 is illustrated, the term “machine” shall also be taken to include a collection of machines that individually or jointly execute the instructions 1208 to perform any one or more of the methodologies discussed herein.

The machine 1200 may include Processors 1202, memory 1204, and I/O Components 1242, which may be configured to communicate with each other via a bus 1244. In an example embodiment, the Processors 1202 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an ASIC, a Radio-Frequency Integrated Circuit (RFIC), another Processor, or any suitable combination thereof) may include, for example, a Processor 1206 and a Processor 1210 that execute the instructions 1208. The term “Processor” is intended to include multi-core Processors that may comprise two or more independent Processors (sometimes referred to as “cores”) that may execute instructions contemporaneously. Although FIG. 12 shows multiple Processors 1202, the machine 1200 may include a single Processor with a single core, a single Processor with multiple cores (e.g., a multi-core Processor), multiple Processors with a single core, multiple Processors with multiples cores, or any combination thereof.

The memory 1204 includes a main memory 1212, a static memory 1214, and a storage unit 1216, both accessible to the Processors 1202 via the bus 1244. The main memory 1204, the static memory 1214, and storage unit 1216 store the instructions 1208 embodying any one or more of the methodologies or functions described herein. The instructions 1208 may also reside, completely or partially, within the main memory 1212, within the static memory 1214, within machine-readable medium 1218 within the storage unit 1216, within at least one of the Processors 1202 (e.g., within the Processor's cache memory), or any suitable combination thereof, during execution thereof by the machine 1200.

The I/O Components 1242 may include a wide variety of Components to receive input, provide output, produce output, transmit information, exchange information, capture measurements, and so on. The specific I/O Components 1242 that are included in a particular machine will depend on the type of machine. For example, portable machines such as mobile phones may include a touch input device or other such input mechanisms, while a headless server machine will likely not include such a touch input device. It will be appreciated that the I/O Components 1242 may include many other Components that are not shown in FIG. 12. In various example embodiments, the I/O Components 1242 may include output Components 1228 and input Components 1230. The output Components 1228 may include visual Components (e.g., a display such as a plasma display panel (PDP), a light emitting diode (LED) display, a liquid crystal display (LCD), a projector, or a cathode ray tube (CRT)), acoustic Components (e.g., speakers), haptic Components (e.g., a vibratory motor, resistance mechanisms), other signal generators, and so forth. The input Components 1230 may include alphanumeric input Components (e.g., a keyboard, a touch screen configured to receive alphanumeric input, a photo-optical keyboard, or other alphanumeric input Components), point-based input Components (e.g., a mouse, a touchpad, a trackball, a joystick, a motion sensor, or another pointing instrument), tactile input Components (e.g., a physical button, a touch screen that provides location and/or force of touches or touch gestures, or other tactile input Components), audio input Components (e.g., a microphone), and the like.

In further example embodiments, the I/O Components 1242 may include biometric Components 1232, motion Components 1234, environmental Components 1236, or position Components 1238, among a wide array of other Components. For example, the biometric Components 1232 include Components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion Components 1234 include acceleration sensor Components (e.g., accelerometer), gravitation sensor Components, rotation sensor Components (e.g., gyroscope), and so forth. The environmental Components 1236 include, for example, illumination sensor Components (e.g., photometer), temperature sensor Components (e.g., one or more thermometers that detect ambient temperature), humidity sensor Components, pressure sensor Components (e.g., barometer), acoustic sensor Components (e.g., one or more microphones that detect background noise), proximity sensor Components (e.g., infrared sensors that detect nearby objects), gas sensors (e.g., gas detection sensors to detection concentrations of hazardous gases for safety or to measure pollutants in the atmosphere), or other Components that may provide indications, measurements, or signals corresponding to a surrounding physical environment. The position Components 1238 include location sensor Components (e.g., a GPS receiver Component), altitude sensor Components (e.g., altimeters or barometers that detect air pressure from which altitude may be derived), orientation sensor Components (e.g., magnetometers), and the like.

Communication may be implemented using a wide variety of technologies. The I/O Components 1242 further include communication Components 1240 operable to couple the machine 1200 to a network 1220 or devices 1222 via a coupling 1224 and a coupling 1226, respectively. For example, the communication Components 1240 may include a network interface Component or another suitable device to interface with the network 1220. In further examples, the communication Components 1240 may include wired communication Components, wireless communication Components, cellular communication Components, Near Field Communication (NFC) Components, Bluetooth® Components (e.g., Bluetooth® Low Energy), Wi-Fi® Components, and other communication Components to provide communication via other modalities. The devices 1222 may be another machine or any of a wide variety of peripheral devices (e.g., a peripheral device coupled via a USB).

Moreover, the communication Components 1240 may detect identifiers or include Components operable to detect identifiers. For example, the communication Components 1240 may include Radio Frequency Identification (RFID) tag reader Components, NFC smart tag detection Components, optical reader Components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection Components (e.g., microphones to identify tagged audio signals). In addition, a variety of information may be derived via the communication Components 1240, such as location via Internet Protocol (IP) geolocation, location via Wi-Fi® signal triangulation, location via detecting an NFC beacon signal that may indicate a particular location, and so forth.

The various memories (e.g., memory 1204, main memory 1212, static memory 1214, and/or memory of the Processors 1202) and/or storage unit 1216 may store one or more sets of instructions and data structures (e.g., software) embodying or used by any one or more of the methodologies or functions described herein. These instructions (e.g., the instructions 1208), when executed by Processors 1202, cause various operations to implement the disclosed embodiments.

The instructions 1208 may be transmitted or received over the network 1220, using a transmission medium, via a network interface device (e.g., a network interface Component included in the communication Components 1240) and using any one of a number of well-known transfer protocols (e.g., hypertext transfer protocol (HTTP)). Similarly, the instructions 1208 may be transmitted or received using a transmission medium via the coupling 1226 (e.g., a peer-to-peer coupling) to the devices 1222.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

### EXAMPLES

Example 1 is a method comprising: accessing image data of consecutive frames generated by one or more cameras of a device; performing a visual Simultaneous Localization and Mapping (SLAM) processing on the image data to detect and track visual features; identifying a region of interest in the image data by detecting one or more clusters of visual features that exhibit at least one of: (a) new features that appear and then lose tracking in the consecutive frames, or (b) existing tracked features that suddenly lose tracking; and performing a hand detection processing in the region of interest.

In Example 2, the subject matter of Example 1 includes, wherein performing the hand detection processing in the region of interest is performed prior to searching an entire image of the consecutive frames for hand detection.

In Example 3, the subject matter of Examples 1-2 includes, determining that a hand is detected with a confidence level above a threshold level in the region of interest; and in response to determining that the hand is detected with the confidence level above the threshold level in the region of interest, skipping the hand detection processing on a remainder of the image data.

In Example 4, the subject matter of Examples 1-3 includes, filtering the one or more clusters based on a predetermined region size threshold; and excluding a cluster that is located outside the predetermined region size threshold based on a hand size and an estimated distance between an arm of a user of the device and the one or more cameras of the device.

In Example 5, the subject matter of Example 4 includes, wherein the hand size is based on at least one of: historical hand tracking data for the user of the device, or a default hand size parameter.

In Example 6, the subject matter of Examples 1-5 includes, wherein performing the hand detection processing comprises a one-stage detection method that adjusts likelihood values for feature grids containing the region of interest, and provides the region of interest as an anchor bounding box to guide a neural network search.

In Example 7, the subject matter of Examples 1-6 includes, wherein performing the hand detection processing comprises a two-stage detection method that skips a first stage bounding box detection, and directly provides the region of interest to a second stage object detection.

In Example 8, the subject matter of Examples 1-7 includes, in response to tracking a hand, limiting an identification of feature clusters to a single side of an image corresponding to the tracked hand.

In Example 9, the subject matter of Examples 1-8 includes, performing a first feature clustering at a first frequency for an image border area; and performing a second feature clustering at a second frequency for a central image area, the second frequency being lower than the first frequency.

In Example 10, the subject matter of Examples 1-9 includes, wherein in the existing tracked features that suddenly lose tracking, patterns indicating potential hand presence comprise: tracked features at a first distance being blocked by an object at a second distance that is closer than the first distance, wherein the second distance corresponds to an expected hand-to-camera distance range.

In Example 11, the subject matter of Examples 1-10 includes, filtering the one or more clusters based on predetermined constraints comprising: calculating an expected cluster size based on: an assumed arm length range, and a predetermined hand size parameter.

In Example 12, the subject matter of Examples 1-11 includes, activating a lower frequency full-image hand detection process when no hands are detected in the region of interest.

Example 13 is a computing apparatus comprising: a processor; and a memory storing instructions that, when executed by the processor, configure the apparatus to: access image data of consecutive frames generated by one or more cameras of a device; perform a visual Simultaneous Localization and Mapping (SLAM) processing on the image data to detect and track visual features; identify a region of interest in the image data by detecting one or more clusters of visual features that exhibit at least one of: (a) new features that appear and then lose tracking in the consecutive frames, or (b) existing tracked features that suddenly lose tracking; and perform a hand detection processing in the region of interest.

In Example 14, the subject matter of Example 13 includes, wherein performing the hand detection process in the region of interest is performed prior to searching an entire image of the consecutive frames for hand detection.

In Example 15, the subject matter of Examples 13-14 includes, wherein the instructions further configure the apparatus to: determine that a hand is detected with a confidence level above a threshold level in the region of interest; and in response to determining that the hand is detected with the confidence level above the threshold level in the region of interest, skip the hand detection processing on a remainder of the image data.

In Example 16, the subject matter of Examples 13-15 includes, wherein the instructions further configure the apparatus to: filter the one or more clusters based on a predetermined region size threshold; and exclude a cluster that is located outside the predetermined region size threshold based on a hand size and an estimated distance between an arm of a user of the device and the one or more cameras of the device.

In Example 17, the subject matter of Example 16 includes, wherein the hand size is based on at least one of: historical hand track data for the user of the device, or a default hand size parameter.

In Example 18, the subject matter of Examples 13-17 includes, wherein performing the hand detection processing comprises a one-stage detection method that adjusts likelihood values for feature grids containing the region of interest, and provides the region of interest as an anchor bounding box to guide a neural network search.

In Example 19, the subject matter of Examples 13-18 includes, wherein performing the hand detection processing comprises a two-stage detection method that skips a first stage bounding box detection, and directly provides the region of interest to a second stage object detection.

Example 20 is a non-transitory computer-readable storage medium, the computer-readable storage medium including instructions that when executed by a computer, cause the computer to: access image data of consecutive frames generated by one or more cameras of a device; perform a visual Simultaneous Localization and Mapping (SLAM) processing on the image data to detect and track visual features; identify a region of interest in the image data by detecting one or more clusters of visual features that exhibit at least one of: (a) new features that appear and then lose tracking in the consecutive frames, or (b) existing tracked features that suddenly lose tracking; and perform a hand detection processing in the region of interest.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method comprising:
accessing image data of consecutive frames generated by one or more cameras of a device;
performing a visual Simultaneous Localization and Mapping (SLAM) processing on the image data to detect and track visual features;
identifying a region of interest in the image data by detecting one or more clusters of visual features that exhibit at least one of: (a) new features that appear and then lose tracking in the consecutive frames, or (b) existing tracked features that suddenly lose tracking; and
performing a hand detection processing in the region of interest.

2. The method of claim 1, wherein performing the hand detection processing in the region of interest is performed prior to searching an entire image of the consecutive frames for hand detection.

3. The method of claim 1, further comprising:
determining that a hand is detected with a confidence level above a threshold level in the region of interest; and
in response to determining that the hand is detected with the confidence level above the threshold level in the region of interest, skipping the hand detection processing on a remainder of the image data.

4. The method of claim 1, further comprising:
filtering the one or more clusters based on a predetermined region size threshold; and
excluding a cluster that is located outside the predetermined region size threshold based on a hand size and an estimated distance between an arm of a user of the device and the one or more cameras of the device.

5. The method of claim 4, wherein the hand size is based on at least one of: historical hand tracking data for the user of the device, or a default hand size parameter.

6. The method of claim 1, wherein performing the hand detection processing comprises a one-stage detection method that adjusts likelihood values for feature grids containing the region of interest, and provides the region of interest as an anchor bounding box to guide a neural network search.

7. The method of claim 1, wherein performing the hand detection processing comprises a two-stage detection method that skips a first stage bounding box detection, and directly provides the region of interest to a second stage object detection.

8. The method of claim 1, further comprising:
in response to tracking a hand, limiting an identification of feature clusters to a single side of an image corresponding to the tracked hand.

9. The method of claim 1, further comprising:
performing a first feature clustering at a first frequency for an image border area; and
performing a second feature clustering at a second frequency for a central image area, the second frequency being lower than the first frequency.

10. The method of claim 1, wherein in the existing tracked features that suddenly lose tracking, patterns indicating potential hand presence comprise:
tracked features at a first distance being blocked by an object at a second distance that is closer than the first distance, wherein the second distance corresponds to an expected hand-to-camera distance range.

11. The method of claim 1, further comprising:
filtering the one or more clusters based on predetermined constraints comprising:
calculating an expected cluster size based on: an assumed arm length range, and a predetermined hand size parameter.

12. The method of claim 1, further comprising:
activating a lower frequency full-image hand detection process when no hands are detected in the region of interest.

13. A computing apparatus comprising:
a processor; and
a memory storing instructions that, when executed by the processor, configure the apparatus to:
access image data of consecutive frames generated by one or more cameras of a device;
perform a visual Simultaneous Localization and Mapping (SLAM) processing on the image data to detect and track visual features;
identify a region of interest in the image data by detecting one or more clusters of visual features that exhibit at least one of: (a) new features that appear and then lose tracking in the consecutive frames, or (b) existing tracked features that suddenly lose tracking; and
perform a hand detection processing in the region of interest.

14. The computing apparatus of claim 13, wherein performing the hand detection process in the region of interest is performed prior to searching an entire image of the consecutive frames for hand detection.

15. The computing apparatus of claim 13, wherein the instructions further configure the apparatus to:
determine that a hand is detected with a confidence level above a threshold level in the region of interest; and
in response to determining that the hand is detected with the confidence level above the threshold level in the region of interest, skip the hand detection processing on a remainder of the image data.

16. The computing apparatus of claim 13, wherein the instructions further configure the apparatus to:
filter the one or more clusters based on a predetermined region size threshold; and
exclude a cluster that is located outside the predetermined region size threshold based on a hand size and an estimated distance between an arm of a user of the device and the one or more cameras of the device.

17. The computing apparatus of claim 16, wherein the hand size is based on at least one of:
historical hand track data for the user of the device, or a default hand size parameter.

18. The computing apparatus of claim 13, wherein performing the hand detection processing comprises a one-stage detection method that adjusts likelihood values for feature grids containing the region of interest, and provides the region of interest as an anchor bounding box to guide a neural network search.

19. The computing apparatus of claim 13, wherein performing the hand detection processing comprises a two-stage detection method that skips a first stage bounding box detection, and directly provides the region of interest to a second stage object detection.

20. A non-transitory computer-readable storage medium, the computer-readable storage medium including instructions that when executed by a computer, cause the computer to:
access image data of consecutive frames generated by one or more cameras of a device;
perform a visual Simultaneous Localization and Mapping (SLAM) processing on the image data to detect and track visual features;
identify a region of interest in the image data by detecting one or more clusters of visual features that exhibit at least one of: (a) new features that appear and then lose tracking in the consecutive frames, or (b) existing tracked features that suddenly lose tracking; and
perform a hand detection processing in the region of interest.
